(19) United States
(12) Patent Application Publication
(10) Pub. No.: US 2013/0156652 A1
(43) Pub. Date: Jun. 20, 2013

(54) Exhaust Gas Emission Control System

(71) Applicants: Toshiyuki Kamei, Oyama-shi (JP); Shouhei Nagasaka, Oyama-shi (JP)

(72) Inventors: Toshiyuki Kamei, Oyama-shi (JP); Shouhei Nagasaka, Oyama-shi (JP)

(21) Appl. No.: 13/697,652

(22) PCT Filed: Feb. 15, 2012
(86) PCT No.: PCT/JP12/53483

§ 371 Date: Nov. 13, 2012

(30) Foreign Application Priority Data
Jul. 5, 2011 (JP) 2011-149027

(51) Int. Cl. B01D 53/94

(52) U.S. Cl. CPC B01D 53/94
USPC 422/170

(57) ABSTRACT

An exhaust gas emission control system includes a cylindrical main body shell and an outlet shell that are detachably connected in series along an exhaust gas flow direction. The exhaust gas emission control system also includes a CSF provided in the main body shell, an insulating mat interposed between the main body shell and the CSF, a bulging portion provided at an end of the main body shell near the outlet shell, and a flare that enlarges toward the main body shell. The main body shell and the outlet shell are mutually connected by a fastener having a V-insert that bridges the bulging portion and the flare. An end of the CSF near the outlet shell projects beyond an end of the insulating mat toward the outlet shell while being positioned inside the end of the main body shell.

### TECHNICAL FIELD

The present invention relates to an exhaust gas emission control system.

### BACKGROUND ART

Typically, an exhaust gas emission control system in which a plurality of cylindrical outer shells are connected in series has been known as a emission control system of exhaust gas discharged from a combustion engine such as a diesel engine. One of the shells houses CSF (Catalyzed Soot Filter) for capturing PM (Particulate Matter) contained in exhaust gas. Another one of the shell connected to an inlet of the first shell houses DOC (Diesel Oxidation Catalyst) that oxidizes a dosing fuel supplied in the exhaust gas to generate heat and increase an exhaust gas temperature (see, for instance, Patent Literatures 1 and 2).

In Patent Literature 1, in order to reduce an entire device in size, an enlarged diameter portion is provided at an outlet of the shell housing DOC (hereinafter, referred to as a DOC-shell) and the inlet of the shell housing CSF (hereinafter, referred to as a CSF-shell) is inserted into the enlarged diameter portion to be fitted, whereby a distance between DOC and CSF is shortened to reduce an overall length of the device. The shells are connected by bringing opposing flanges into contact and fastening nuts and bolts penetrating the flanges.

However, in the structure of Patent Literature 1, since one shell is inserted into the other shell to be fitted, when thermal stress is generated by heat of exhaust gas, the shell are deformed to hamper an easy disassemble, so that cleaning and maintenance (e.g., replacement) of the CSF become difficult.

Accordingly, as disclosed in Patent Literature 2, there may be considered such a configuration that a fitting portion of Patent Literature 1 is eliminated and an inlet of the CSF is inserted into the DOC-shell.

### CITATION LIST

### Patent Literature(s)

Patent Literature 1: JP-A-2004-263593

Patent Literature 2: JP-A-2011-012618

### SUMMARY OF THE INVENTION

### Problems to be Solved by the Invention

However, in Patent Literature 2, both the DOC and the CSF are housed in the shells when the exhaust gas emission control system is in an assembled state, whereas the CSF projects beyond the shell housing the CSF to the extent where the CSF is inserted into the DOC-shell and is exposed when the exhaust gas emission control system is in a disassembled state. Accordingly, during the maintenance, the projecting portion of the CSF may be contacted with other component(s) to be broken, so that a careful handling is necessary.

When a connection position by the flanges is significantly shifted closer to the DOC-shell such that the CSF is completely housed in the CSF-shell, the flanges becomes too close to an insulating material covering an outer circumference of the DOC-shell, so that manipulation of the bolts penetrating the flanges and the nuts screwed onto the bolts becomes complicated and disassembly and assembly cannot be rapidly conducted. Further, depending on the configuration of the device, the flanges may be too close to an exhaust pipe or a temperature sensor, which causes the same problem.

An object of the invention is to provide an easily handleable exhaust gas emission control system capable of being rapidly assembled/disassembled and the like with a small size.

### Means for Solving the Problems

According to a first aspect of the invention, an exhaust gas emission control system includes: cylindrical first shell and second shell that are detachably connected in series along an exhaust gas flow direction; a bulging portion provided at an end of the first shell near the second shell, the bulging portion bulging radially outward; a flare provided at an end of the second shell near the first shell, the flare enlarging toward the first shell; and an inner packing member that is held via an insulating mat at least inside the first shell of the first shell and the second shell, in which an end near the second shell of the inner packing member provided inside the first shell projects beyond an end of the insulating mat toward the second shell but does not project beyond the end of the first shell, and the first shell and the second shell are mutually connected by a fastener provided with a V-insert that bridges the mutually close bulging portion and the flare.

According to a second aspect of the invention, the end of the inner packing member near the second shell is positioned near the second shell beyond a minimum projecting margin from the insulating mat which is necessary for an assembly step.

According to a third aspect of the invention, the end of the inner packing member near the second shell is positioned within a range of the bulging portion.

According a fourth aspect of the invention, a volume of the inner packaging member projecting from the end of the insulating mat is set at a value such that a stress generated on the inner packaging member by a bending moment does not exceed an allowable stress of the inner packaging member.

According to the first aspect of the invention, the end of the inner packing member (e.g., CSF) provided in the first shell is either flash with the end of the insulating mat or positioned near the second shell beyond the end of the insulating mat. In other words, the end of the inner packing member is shifted near the second shell away from the insulating mat by a volume of the inner packing member beyond the end of the insulating mat. Accordingly, an opposite end (i.e., an end opposite to the end near the second shell) of the first shell can be shortened in length, which contributes to a reduction in size of the entire device.

Moreover, since the end of the inner packing member does not project beyond an end of the shell in which the inner packing member is contained and the fastener having the V-insert is used instead of a conventional means of plural nuts and bolts penetrating along a connection direction, the bulging portion can be enlarged and provided closer to the second shell. Consequently, the end of the inner packing member is completely covered with the first shell. Even when the first shell with the inner packing member housed therein is removed from the device and left, the fragile inner packing member is not exposed and can be prevented from damage caused by contact with other component(s).

The fastener for connecting the first and second shells is configured to connect the bulging portion and the flare of the respective shells by approaching each other using a wedge effect. In order to exhibit the wedge effect, a band integrated with the V-insert, a single bolt for fastening both ends of the band, and a nut screwed onto the bolt are only necessary. Accordingly, it is only necessary to manipulate the nut at a time of assembly and disassembly, so that a favorable operability can be obtained.

According to the second aspect of the invention, since the end of the inner packing member projects beyond the minimum projecting margin from the insulating mat, the surrounding of the projecting portion uncovered with the insulating mat is heated by exhaust gas. For instance, when the inner packing member is the CSF, the CSF can rapidly be regenerated as compared with when only an end of the CSF is exposed.

According to the third aspect of the invention, since the end of the inner packing member is provided within a large inner space formed by the bulging portion, the end of the inner packing member is further exposed. For instance, when the inner packing member is CSF, the surrounding of the projecting portion of the CSF can be effectively heated by exhaust gas, so that the CSF can be more rapidly regenerated.

According to the fourth aspect of the invention, since the end of the inner packing member projects within the allowable stress by the bending moment, the insulating mat is not cracked at a holding portion and durability of the inner packing member is maintainable.

### BRIEF DESCRIPTION OF DRAWINGS

FIG. 1 is a sectional side elevation showing an entirety of an exhaust gas emission control system according to an exemplary embodiment of the invention.

FIG. 2 is an enlarged cross-sectional view showing a primary part of the exhaust gas emission control system according to the above exemplary embodiment and is an enlarged view of a circle II of FIG. 1.

FIG. 3 is an enlarged partially sectional side elevation of a primary part of a fastener used in the above exemplary embodiment.

FIG. 4 is an enlarged cross-sectional view showing another primary part according to the above exemplary embodiment and is an enlarged view of a circle IV of FIG. 1.

### DESCRIPTION OF EMBODIMENT(S)

An exemplary embodiment of the invention will be described below with reference to the attached drawings.

Hereinafter, an upstream side in an exhaust gas flow direction is referred to as an “upstream side” and a downstream side in the exhaust gas flow direction is referred to as a “downstream side.” The upstream side and an inlet side may be used for expressing the same meaning. The downstream side and an outlet side may be used for expressing the same meaning.

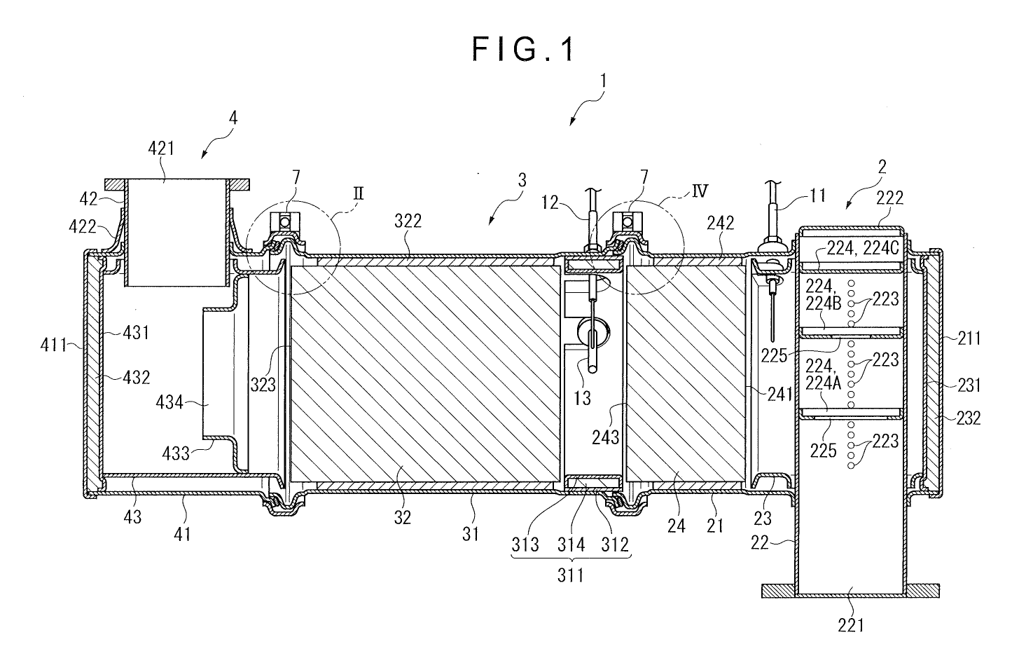

FIG. 1 shows an exhaust gas emission control system 1 according to the exemplary embodiment.

The exhaust gas emission control system 1 is provided in an exhaust pipe of a diesel engine (not shown) for capturing PM contained in exhaust gas. Specifically, the exhaust gas emission control system 1 includes an inlet body 2 provided on the farthest upstream side (a right side of the drawing); a main body 3 provided to the inlet body 2 on the downstream side; and an outlet body 4 provided on the farthest downstream side. Each of the bodies 2, 3 and 4 is a cylinder made of metal such as a stainless steel. The bodies 2, 3 and 4 respectively include an inlet shell 21, a main body shell 31 and an outlet shell 41, which are detachably connected in series along an exhaust gas flow direction.

### Description of Inlet Body

The inlet body 2 includes: the inlet shell 21; a cylindrical inlet pipe 22 that vertically penetrates an outer circumference of the inlet shell 21; an inner cylindrical member 23 that is housed in the inlet shell 21 and through which the inlet pipe 22 is inserted; and a columnar the DOC 24 that is provided on the downstream side of the inner cylindrical member 23.

One end (on a side opposite to the main body 3: the far right in the drawing) of the cylindrical inlet shell 21 is covered with an outer plate 211 while the other end of the cylindrical inlet shell 21 is open toward the main body 3.

The inlet pipe 22 vertically penetrates the inlet shell 21 and the inner cylindrical member 23, projects downward so that an inlet 221 faces downward, and is welded to the inlet shell 21. A lower end of the inlet pipe 22 near the inlet 221 is connected to the exhaust pipe from the engine while an upper end of the inlet pipe 22 is covered with a plate 222. In an overall area of the inlet pipe 22 corresponding to an inside of the inlet shell 21, a number of circular holes 223 are provided (shown in one vertical line for simplifying the drawing). Through the circular holes 223, the exhaust gas flows in the inlet shell 21.

Three adjusting plates 224 (224A, 224B, 224C) are attached to the inlet pipe 22 and arranged in a longitudinal direction while being spaced away from each other in an inflow direction of the exhaust gas. The two adjusting plates 224A and 224B on the upstream side respectively have openings 225 that each penetrate from a top to a bottom of the adjusting plates 224A and 224B. The opening 225 of the adjusting plate 224A attached on the upstream side has a larger opening area than the opening 225 of the adjusting plate 224B. Consequently, a flow rate of the exhaust gas flowing into a space sectioned by each of the adjusting plates 224 is adjusted and the exhaust gas flowing out of the entire inlet pipe 22 is widespread in the inlet shell 21 to provide a uniform distribution of the exhaust gas, whereby the exhaust gas uniformly flows in over an entire inlet end surface of the DOC 24.

The inner cylindrical member 23 is a substantially cylindrical member for allowing heat by the exhaust gas flowing out of the inlet pipe 22 to be less likely to be transmitted to the inlet shell 21. One end of the inner cylindrical member 23 is covered with an inner plate 231 while the other end of the inner cylindrical member 23 is open toward the DOC 24. After the inner cylindrical member 23 is housed in the inlet shell 21, an outer circumference of the inner plate 231 is welded to an inner circumference of the inlet shell 21. Herein, the inner plate 231 faces the outer plate 211 of the inlet shell 21 with a predetermined interval therebetween. Between the plates 211 and 231, an insulating mat 232 made of ceramic fibers or glass fibers is interposed.

The DOC 24 serves to oxidize a dosing fuel added to the exhaust gas as needed to generate heat therefrom, thereby raising the temperature of the exhaust gas to a predetermined high-temperature range. The heated exhaust gas allows PM accumulated in a later-described CSF 32 to combust for removal, thereby regenerating the CSF 32.

The dosing fuel is the same light oil as an engine fuel when the combustion engine is a diesel engine. The dosing fuel is added to the exhaust gas by a dosing fuel injector provided to the exhaust pipe to which the inlet pipe 22 is connected and then flows into the exhaust gas emission control system 1 along with the exhaust gas. When the dosing fuel is fed into an engine cylinder, a fuel injector for the engine cylinder is also used to feed the dosing fuel.

Between the DOC 24 and the inlet shell 21, an insulating mat 242 is interposed while being compressed. A material for the insulating mat 242 is the same as that for the above-described insulating mat 232. Herein, the insulating mat 242 serves as a holding member that holds the DOC 24 using a reaction force (an elastic force) against compression.

### Description of Main Body

The main body 3 includes: a main body shell 31; and the CSF 32 that is housed in the main body shell 31 and captures PM contained in the exhaust gas.

Inside the main body shell 31, an annular member 311 having a predetermined thickness is provided on the inlet side. The annular member 311 includes: an annular plate 312 that is contacted with an inner circumference of the main body shell 31; and an annular square-C-shaped member 313 having a square-C-shaped cross section which is open toward the annular plate 312, in which the annular plate 312 and the annular square-C-shaped member 313 are connected (e.g., welded) to each other. In an inner space defined by the annular plate 312 and the annular square-C-shaped member 313, an insulating mat 314 is housed.

The CSF 32 is configured to have a number of pores although a detailed illustration of the CSF 32 is omitted. The pores penetrate the CSF 32 from an inflow side to an outflow side and have a polygonal (e.g., hexagonal) cross-section. The pores are provided by a first configuration in which a pore is open on the inlet side while being closed on the outlet side, and by a second configuration in which a pore is closed on the inlet side while being open on the outlet side, the first configuration and the second configuration being alternately provided. The exhaust gas inflowing from the pores of the first configuration passes through a boundary wall to flow in the pores of the second configuration, eventually flowing out to the downstream side. PM are captured by the boundary wall.

A material for the CSF 32 is ceramics such as cordierite and silicon carbide, or metal such as stainless steel and aluminium and is appropriately determined depending on usage. The CSF 32 on the inlet side may be coated with an oxidization catalyst made of a material different from the DOC 24 by wash-coating.

Also between such the CSF 32 and the main body shell 31, an insulating mat 322 is interposed while being compressed. A material for the insulating mat 322 is the same as that for the above-described insulating mat 314. The same material is used for a later-described insulting mat 432. Herein, the insulating mat 322 also serves as a holding member that holds the CSF 32 using a reaction force against compression.

### Description of Outlet Body

The outlet body 4 includes: an outlet shell 41; a cylindrical outlet pipe 42 that is inserted in an upper outer-circumference of the outlet shell 41; and an inner cylindrical member 43 that is housed in the outlet shell 41 and through which the outlet pipe 42 is inserted.

One end (on a side opposite to the main body 3: the far left in the drawing) of the cylindrical outlet shell 41 is covered with a disc-shaped outer plate 411 while the other end of the cylindrical outlet shell 41 is open toward the main body 3.

The outlet pipe 42 penetrates an upper portion of the outlet shell 41 and the inner cylindrical member 43, projects upward so that an outlet 421 faces upward, and is welded to the inlet shell 21 directly or via a circular reinforcing member 422.

The inner cylindrical member 43 is a member for making it difficult to transmit heat of the exhaust gas flowing out of CSF 32 to the outlet shell 41. One end of the inner cylindrical member 43 is covered with an inner plate 431 while the other end of the inner cylindrical member 23 is open toward CSF 32. After the inner cylindrical member 43 is housed in the outlet shell 41, an outer circumference of the inner plate 431 is welded to an inner circumference of the outlet shell 41. Herein, the inner plate 431 faces the outer plate 411 of the outlet shell 41 with a predetermined interval therebetween. Between the plates 211 and 432, an insulating mate 432 is interposed.

A water stop member 433 having a diameter reduced toward the outlet side is provided inside the inner cylindrical member 43 near the inlet side. An opening 434 provided in a reduced diameter portion of the water stop member 433 is positioned above the bottom of the inner cylindrical member in which rain water easily accumulates, so that rain water is prevented from infiltrating into the CSF 32. Since the CSF 32 may be broken or a function of the CSF 32 may be decreased when rain water wets the CSF 32 by infiltrating into the CSF 32 through a tail pipe and the outlet pipe 42, the water stop member 433 serves to prevent rain water from infiltrating into the CSF 32.

The above-described exhaust gas emission control system 1 includes: a temperature sensor 11 that is provided between the inlet pipe 22 and the DOC 24 and penetrates the inlet shell 21 and the inner cylindrical member 23; and a temperature sensor 12 that is provided between the DOC 24 and the CSF 32 and penetrates the main body shell 31 and the annular member 311. Based on exhaust gas temperatures obtained by the temperature sensors 11 and 12, the supply of the dosing fuel is controlled. The exhaust gas emission control system 1 further includes a differential pressure sensor 13 that detects a differential pressure between pressures of the CSF 32 on the upstream and downstream sides. The differential pressure obtained by the differential pressure sensor 13 is used as information for judging a clogging degree of the CSF 32.

Detailed Description of Connecting Portion between Main Body and Outlet Body

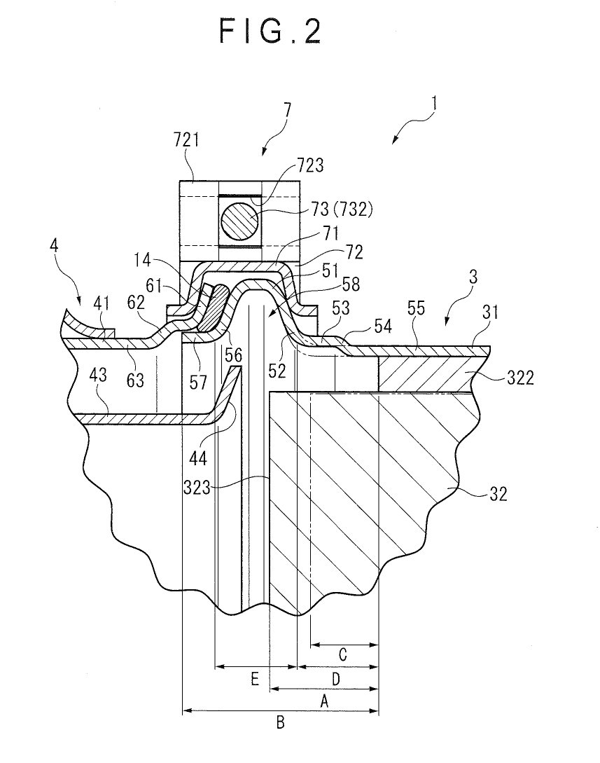

FIG. 2 shows an enlarged primary part of a connecting portion between the main body 3 and the outlet body 4.

In FIG. 2, a bulging portion 51 having a chevron shape and bulging radially outward is provided at an end of the main body shell 31 of the main body 3 near the outlet shell 41. On the upstream side of the bulging portion 51, a first flat portion 53 is provided via a bent portion 52. On the upstream side of the first flat portion 53, a reduced-diameter second flat portion 55 is provided via a step 54. On the other hand, on the downstream side of the bulging portion 51, a third flat portion 57 is provided via a bent portion 56.

An insulating mat 322 is interposed between the second flat portion 55 and the CSF 32 while being compressed. The second flat portion 55 is set to have an inner diameter so as to generate an appropriate elastic force for holding the CSF 32 by the compressed insulating mat 322. In other words, even if an end of the insulating mat 322 significantly projects toward the bulging portion 51, the insulating mat 322 does not serve for holding the CSF 32 because an inner diameter of the first flat portion 53 and the following area on the downstream side is too large to favorably compress the insulating mat 322, so that an appropriate elastic force is not generated. Accordingly, the insulating mat 322 is interposed in the area of the second flat portion 55.

When a distance between the end of the insulating mat 322 on the downstream side and an end of the CSF 32 on the downstream side is represented by A, a distance between the end of the insulating mat 322 on the downstream side and an end of the main body shell 31 on the downstream side is represented by B, a distance between the end of the insulating mat 322 on the downstream side and a position shown by a chain line in the drawing is represented by C, and a distance between the end of the insulating mat 322 on the downstream side and the bent portion 52 provided to the bulging portion 51 on the upstream side is represented by D, the following formulae (1) to (3) are satisfied.

0<A≦B (1)

C<A≦B (2)

D≦A≦B (3)

The formula (1) expresses that the end of the CSF 32 projects beyond the end of the insulating mat 322 while being positioned inside the end of the main body shell 31, in other words, the CSF 32 projecting beyond the end of the insulating mat 322 is completely covered with the main body shell 31. Since the projecting part of the CSF 32 is covered, when the main body 3 is removed, the CSF 32 is not exposed out of the main body shell 31 and is less likely to contact with other component(s) even when being left with the main body 3 being detached, so that breakage and the like of the CSF 32 is effectively prevented.

In the formula (2), C represents a minimum projecting-margin of the CSF 32 necessary for an assembly step. Accordingly, the formula (2) means that the formula (1) is satisfied and the end of the CSF 32 projects beyond the projecting margin from the end of the insulating mat 322. The insulating mat 322 is wound around the CSF 32 in advance. The insulating mat 322 wound around the CSF 32 is compressed into the main body shell 31. Herein, by winding the insulating mat 322 around the insulating mat 322 in such a manner that the CSF 32 projects beyond the insulating mat 322 by the minimum projecting-margin, a surrounding of the projecting portion that is not covered with the insulating mat 322 is heated by exhaust gas, so that the CSF 32 can be rapidly regenerated as compared with when only the end of the CSF 32 is exposed.

The formula (3) means that the formula (1) is satisfied and the end of the CSF 32 projects toward the downstream side farther than a distance from the end of the insulating mat 322 to an inner space 58 provided by a bulge in the bulging portion 51. Specifically, the end of the CSF 32 according to this exemplary embodiment is positioned within “E” that shows a range between the bent portions 52 and 56 (i.e., the bulging portion 51). Since the first flat portion 53 is formed in the bulging portion 51 on the upstream side, the first flat portion 53 is provided by a narrower space with a reduced diameter than the large inner space 58 in the bulging portion 51. Accordingly, when the end of the CSF 32 is positioned in such a narrow space, the range of the projecting portion uncovered with the insulating mat 322 is narrow, so that heating effect by exhaust gas is limited. When the end of the CSF 32 is positioned in the large inner space 58 inside the bulging portion 51, the end of the CSF 32 is further exposed, so that the surrounding of the projecting portion is further effectively heated by exhaust gas to rapidly regenerate the CSF 32. Depending on the design of the main body shell 31, the first flat portion 53 and the step 54 do not exist, but a second flat portion 55 is provided on the upstream side of the bulging portion 51 via the bent portion 52 as shown in a two-dot chain line. In such a case, the above effect is eminent.

However, when the CSF 32 excessively projects from the end of the insulating mat 322, a bending moment generated by vibration and the like in a projecting end of the CSF 32 becomes larger than a bending moment generated in a contact portion of the CSF 32 with the end of the insulating mat 322, so that stress may concentrate on the contact portion to damage the contact portion. Accordingly, when the end of the CSF 32 does not project beyond the end of the main body shell 31, the end of the CSF 32 is positioned such that a volume of the projecting the CSF 32 ranges within an allowable stress due to the bending moment. Thus, the end of the CSF 32 does not project beyond the end of the insulating mat 322 out of the range of the allowable stress. A position of the end of the CSF 32 according to this exemplary embodiment is within the large inner space 58 formed in the bulging portion 51 and is set slightly closer to the upstream side away from a top of the bulging portion 51.

The outlet body 4 will be described below.

A flare 61 having a diameter enlarging toward the upstream side is provided at an end of the outlet shell 41 of the outlet body 4. The maximum diameter of the flare 61 is substantially the same as a diameter of the top of the bulging portion 51. On the downstream side of the flare 61, a flat portion 63 is provided via a step 62. For connecting the flare 61 to the main body shell 31, the flare 61 faces an inclined surface on the downstream side of the bulging portion 51 provided in the main body shell 31 and is brought into contact with the inclined surface via a packing 14. In this arrangement, the end of the main body shell 31 is positioned on an inside of the step 62.

Moreover, a flare 44 is also provided at an end of the inner cylindrical member 43 on the upstream side. A position of the flare 44 is slightly closer to the downstream side away from the top of the bulging portion 51 and is close to an outlet end surface 323 of the CSF 32. With this arrangement that the end of the CSF 32 is close to the end of the inner cylindrical member 43, exhaust gas is prevented from a direct contact with a body connecting portion, which contributes to an improvement in heat insulation of the body connecting portion. In addition, exhaust gas flowing out of the outlet end surface 323 of the CSF 32 can be smoothly flowed into the inner cylindrical member 43 to efficiently discharge the exhaust gas.

The above-described main body 3 and outlet body 4 are connected by a fastener 7.

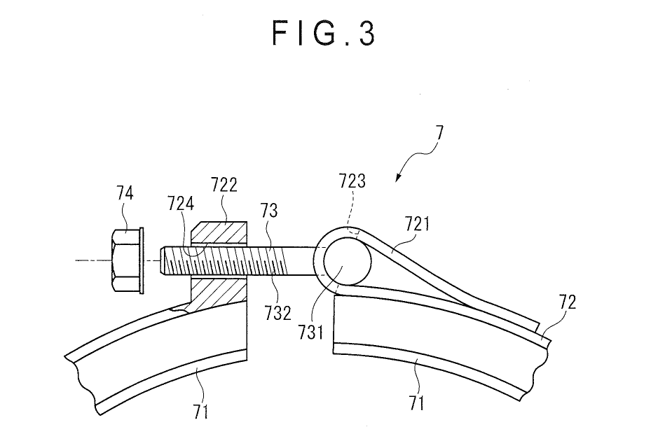

In FIGS. 2 and 3, the fastener 7 includes: a V-insert 71 that is wound around the bulging portion 51 of the main body shell 31 and the flare 61 of the outlet shell 41 in a manner to bridge the bulging portion 51 and the flare 61, the bulging portion 51 and the flare 61 being in contact with each other; a band 72 that is integrated with the V-insert 71 along an outer circumference of the V-insert 71; a bolt 73 that connects ends of the band 72; and a nut 74 screwed onto the bolt 73.

A plurality of the V-inserts 71 having a predetermined length are circumferentially disposed at regular intervals. The band 72 is attached so as to connect the plurality of the V-inserts 71. A cross section of the V-insert 71 is a shape enlarging toward the bulging portion 51 and the flare 61. The V-insert 71 is fitted so as to be contacted with an inclined surface of the bulging portion 51 on the upstream side and a back surface of the flare 61 (i.e., an inclined surface opposite to the packing 14).

One end of the band 72 is folded upward to form a folded portion 721, into which a shaft 731 of the bolt 73 near the base is inserted. A male screw 732 integrated with the shaft 731 of the bolt 73 projects beyond an opening 723 provided in the folded portion 721 and is rotatable along with the shaft 731.

On the other hand, the other end of the band 72 is provided with a bolt insertion portion 722. The bolt insertion portion 722 is provided with an insertion hole 724 into which the male screw 732 of the bolt 73 is inserted. The nut 74 is screwed on a tip end of the inserted male screw 732.

In order to connect the main body 3 and the outlet body 4, the V-insert 71 of the fastener 7 is fitted in a manner to bridge the bulging portion 51 and the flare 61, and the nut 74 screwed on the male screw 732 is fastened. As the nut 74 is fastened, the V-insert 71 is moved radially inward, so that the bulging portion 51 and the flare 61 are further fitted to each other to serve as a wedge. Consequently, the bulging portion 51 and the flare 61 are compressed in a direction to approach each other to be connected.

Thus, in order to connect the main body 3 and the outlet body 4, unlike a conventional way of contacting flanges with each other and fastening a bolt that penetrates the flanges and a nut, neither a bolt significantly projecting along a connection direction of the bodies 3 and 4 nor a nut exists. Accordingly, in addition to facilitating an assembly operation and a disassembly operation, the, connecting portion between the bodies 3 and 4 is brought closer to the outlet pipe 42 (only a part of the reinforcing member 422 is shown in FIG. 2), so that the CSF 32 is reliably covered with the main body shell 31 and, as described above, the CSF 32 is not exposed out of the main body shell 31 even when the main body 3 is removed.

Since connection between the bulging portion 51 and the flare 61 using the fastener 7 is performed only by manipulating the nut 74 screwed on the single bolt 73, assembly and disassembly are facilitated and operability is remarkably improvable as compared with the conventional flange-type connection using plural bolts and nuts circumferentially disposed.

Detailed Description of Connecting Portion between Main Body and Inlet Body

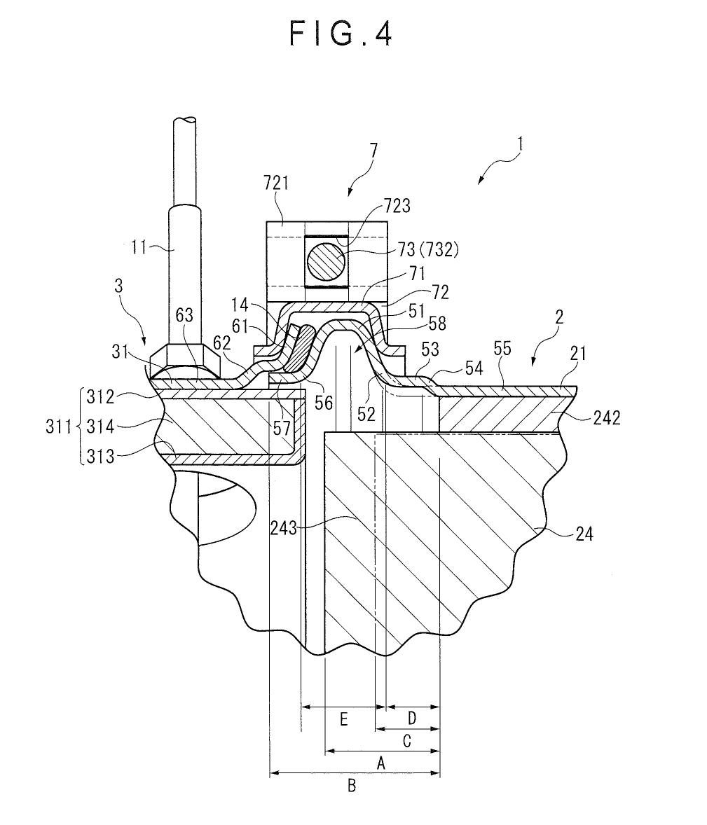

FIG. 4 shows an enlarged primary part of a connecting portion between the main body 3 and the inlet body 2.

Since the connection structure between the main body 3 and the inlet body 2 is basically the same as that between the main body 3 and the outlet body 4, the same functional portions and members are denoted by the same reference numerals shown in FIG. 2, and the descriptions thereof will be omitted or simplified below.

Specifically, in FIG. 4, when the flare 61 provided at the end of the main body shell 31 on the upstream side is connected to the inlet shell 21 of the inlet body 2, the flare 61 faces the inclined surface on the downstream side of the bulging portion 51 provided in the inlet shell 21 and is brought into contact with the inclined surface via the packing 14. In this arrangement, the end of the inlet shell 21 is positioned on the inner side of the step 62 of the main body shell 31.

A position of an end of the DOC 24 in the inlet shell 21 is within the large inner space 58 formed in the bulging portion 51 and is set slightly closer to the downstream side away from the top of the bulging portion 51. A position of an end on the upstream side of the annular member 311 in the main body 31 is very close to the bulging portion 51 of the inlet shell 21 and is close to an outlet end surface 243 of the DOC 24. With this arrangement that the end of the DOC 24 is close to the annular member 311, even when a total length of the inlet body 2 is reduced, the DOC 24 having a sufficient length is usable, which can contribute to a reduction in size of the entire exhaust gas emission control system 1.

Also, in order to connect the main body 3 and the inlet body 2, since a conventional way of contacting flanges with each other and fastening a bolt that penetrates the flanges and a nut is not necessary, neither a bolt significantly projecting along a connection direction of the bodies 2 and 3 nor a nut exists. Accordingly, in addition to favorable operability, since the connecting portion between the bodies 2 and 3 is brought closer to the temperature sensor 11 to reliably cover the DOC 24 with the inlet shell 21, the DOC is not exposed out of the main body shell 31 to prevent damage on the DOC 24 even when the inlet body 2 is removed.

Incidentally, the present invention is not limited to the above-described present embodiments, but includes modifications and improvements as long as the objects of the present invention can be achieved.

For instance, in the above exemplary embodiment, the DOC 24 is completely covered with the inlet shell 21 and the CSF 32 is completely covered with the main body shell 31. However, in the invention, it is only necessary that at least the CSF 32 is completely covered with the main body shell 31. Accordingly, such an arrangement that the end of the DOC 24 is exposed out of the inlet shell 21 is included in the invention.

In the above exemplary embodiment, the DOC 24 is provided in order to increase the temperature of exhaust gas. However, the invention is applicable to an exhaust gas emission control system 1 including only the CSF 32 without the DOC 24.

An inner packing member of the invention may be the DOC 24 in addition to the CSF 32. Moreover, any member holdable via the insulating mat is usable. In other words, when the inner packing member is provided by the CSF 32, the main body shell 31 corresponds to the first shell of the invention and the outlet shell 41 corresponds to the second shell of the invention. When the inner packing member is provided by the DOC 24, the inlet shell 21 corresponds to the first shell of the invention and the main body shell 31 corresponds to the second shell of the invention.

In the above exemplary embodiment, the inlet pipe 22 and the outlet pipe 42 are provided in a manner to respectively project in the radial direction relative to the shells 21 and 41. However, the inlet pipe 22 and the outlet pipe 42 may respectively project along the connection direction (i.e., an axial direction) of the shells 21 and 41. It can be determined as needed in considering a space for arranging the inlet pipe 22 and the outlet pipe 42 in an engine room whether the inlet pipe 22 and the outlet pipe 42 project either in the radial direction or in the connection direction.

### INDUSTRIAL APPLICABILITY

The invention is suitably applicable to an exhaust gas emission control system for a construction machine such as a bulldozer and an excavator.

### EXPLANATION OF CODES

1: exhaust gas emission control system, 7: fastener, 31: main body shell, 32: CSF, 41: outlet shell, 51: bulging portion, 58: inner space, 61: flare, 71: V-insert, 322: insulating mat

1. An exhaust gas emission control system comprising:
cylindrical first shell and second shell that are detachably connected in series along an exhaust gas flow direction;
a bulging portion provided at an end of the first shell near the second shell, the bulging portion bulging radially outward;
a flare provided at an end of the second shell near the first shell, the flare enlarging toward the first shell; and
an inner packing member that is held via an insulating mat at least inside the first shell of the first shell and the second shell, wherein
an end near the second shell of the inner packing member provided inside the first shell projects beyond an end of the insulating mat toward the second shell but does not project beyond the end of the first shell, and
the first shell and the second shell are mutually connected by a fastener provided with a V-insert that bridges the mutually close bulging portion and the flare.

2. The exhaust gas emission control system according to claim 1, wherein
the end of the inner packing member near the second shell is positioned near the second shell beyond a minimum projecting margin from the insulating mat which is necessary for an assembly step.

3. The exhaust gas emission control system according to claim 1, wherein
the end of the inner packing member near the second shell is positioned within a range of the bulging portion.

4. The exhaust gas emission control system according to claim 1, wherein
a volume of the inner packing member projecting from the end of the insulating mat is set at a value such that a stress generated on the inner packing member by a bending moment does not exceed an allowable stress of the inner packing member.
